(19) United States
(12) Patent Application Publication
(10) Pub. No.: US 2008/0065489 A1
(43) Pub. Date: Mar. 13, 2008

(54) METHOD OF PROVIDING FUNERAL SERVICES AND MERCHANDISE

(76) Inventor: Crystal B. Walker, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/854,836

(22) Filed: Sep. 13, 2007

Related U.S. Application Data
(60) Provisional application No. 60/825,495, filed on Sep. 13, 2006.

(51) Int. Cl. G06Q 30/00

(52) U.S. Cl. 705/14

(57) ABSTRACT

A method for providing funeral services and funeral related merchandise includes the steps of providing a membership company for offering and administering memberships, in which the membership company charges and collects a fee from members, and enters agreements with providers of funeral services and funeral related merchandise. The providers agree to provide the funeral services and the funeral related merchandise at a predetermined price to members of the membership company that is discounted below a price charged by the providers to the general public for such services and merchandise. The membership company also charges and collects a fee from the providers.

This application claims priority to U.S. Provisional Patent Application No. 60/825,495, filed Sep. 13, 2006. The present invention relates to the field of providing funeral services and related merchandise.

### TECHNICAL FIELD AND BACKGROUND OF THE INVENTION

When planning a funeral for a loved one, family members are faced with difficult decisions regarding the types of caskets, flowers, services, vaults, urns and other associated items. Unfortunately, many of these decisions are dictated by price, and because of the high cost associated with funeral services, many families are unable to provide their loved one with the type of funeral that they would like.

Typically, funeral services, flowers, caskets, and other items are purchased from or through the funeral home conducting the funeral services. This results in the items being purchased at a premium because of the mark-up by the funeral home that is included in the price of each item. Thus, this can result in a family or organization, such as a church, incurring a substantial expense to have a funeral.

### SUMMARY OF THE INVENTION

Therefore it is an object of the invention to provide a method of providing funeral services and related merchandise that allows individuals, families and organizations to pay for the services and merchandise in advance.

It is another object of the invention to provide a method of providing funeral services that allows families and organizations to purchase items associated with a funeral service at a discounted price.

These and other objects of the present invention can be achieved in the various embodiments of the invention described below. One embodiment of the invention comprises a method for providing funeral services and related merchandise that includes the steps of providing a membership company for offering and administering memberships, in which the membership company charges and collects a fee from members, and entering agreements with providers of funeral services and funeral related merchandise, in which the providers agree to provide the funeral services and the funeral related merchandise at a predetermined price to members of the membership company.

According to another preferred embodiment of the invention, the memberships are for a predetermined period of time, such as monthly, annual or semi-annual.

According to another preferred embodiment of the invention, the predetermined price is discounted below a price charged by the providers to the general public for such services and merchandise.

According to another preferred embodiment of the invention, the membership company charges and collects a fee from the providers.

According to another preferred embodiment of the invention, the funeral related merchandise includes caskets, flowers, urns, burial garments, and/or vaults.

According to another preferred embodiment of the invention, the membership company is alerted of the death of one of its members through a communication means such as electronic mail, telephone, or an Internet website.

According to another preferred embodiment of the invention, the membership company verifies a member's membership, and then provides access to an on-line store selling funeral related merchandise at a discounted price.

According to another preferred embodiment of the invention, the membership company collects payment from members for funeral services and/or funeral related merchandise.

According to another preferred embodiment of the invention, the membership company offers funeral services or funeral related merchandise to non-members at a price higher than the predetermined price charged to members of the membership company.

According to another preferred embodiment of the invention, the memberships offered and administered by the membership company are classified into a plurality of tiered membership levels, in which each level provides varying benefits to the members.

According to another preferred embodiment of the invention, the membership company offers and administers corporate memberships and individual/family memberships.

According to another preferred embodiment of the invention, the corporate memberships are for entities such as churches, nursing homes, rest homes, hospice care facilities, for-profit business entities, and non-profit entities.

According to another preferred embodiment of the invention, the corporate memberships are classified into a plurality of tiered membership levels based on the number of individuals within a member entity.

According to another preferred embodiment of the invention, tiered membership levels include a first tier comprised of entities having one to five hundred individuals, a second tier comprised of entities having 501 to 1000 individuals, a third tier comprised of entities having 1001-2500 individuals, a fourth tier comprised of entities having 2501-5000 individuals, and a fifth tier comprised of entities having more than five thousand individuals.

### BRIEF DESCRIPTION OF THE DRAWINGS

The invention may be best understood by reference to the following description in conjunction with the accompanying drawing figures in which:

FIG. 1 is a schematic of a method of providing funeral services according to an embodiment of the invention.

### DESCRIPTION OF THE PREFERRED EMBODIMENT AND BEST MODE

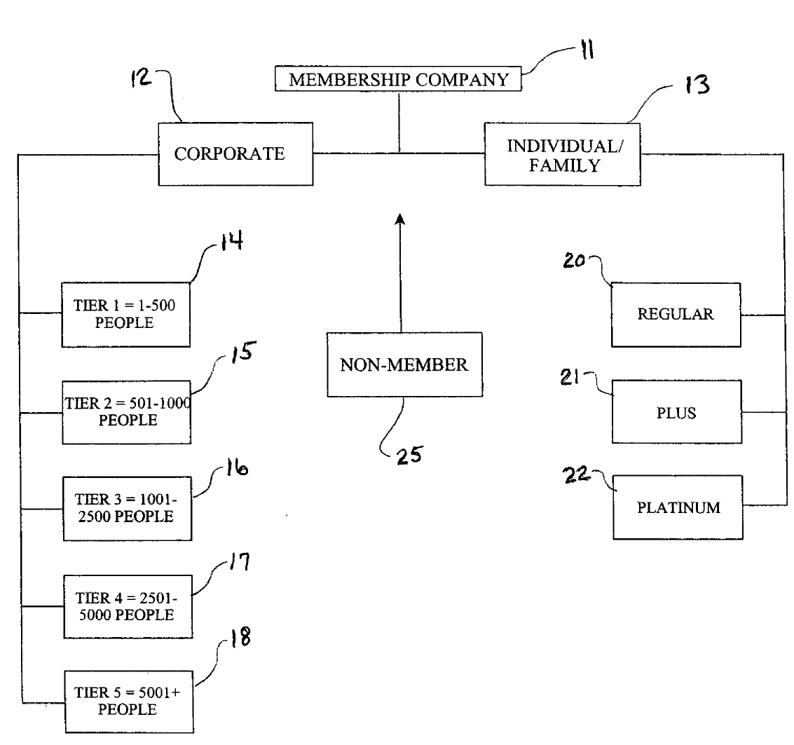

Referring now specifically to the drawings, a method of providing funeral services and related merchandise according to an embodiment of the invention is illustrated in FIG. 1 and shown generally at reference numeral 10. The method 10 uses a membership system that is divided into a corporate membership (block 12) and an individual/family membership (block 13). The memberships are administered by a membership company (block 11), and may be monthly, annual, semi-annual or any other particular time period, and allow access to funeral services and merchandise at a discounted price. Members will be able to purchase services (provided by service companies having an agreement with the membership company (block 11)) or merchandise at local membership stores, on-line, or by other suitable means. In addition to an agreement between the service companies and the membership company, the service companies will be required to pay the membership company a fee for being a member of the membership system/network.

The corporate membership (block 12) is used for churches, nursing homes, rest homes, hospice care facilities, for-profit corporations, and non-profit entities. The corporate membership (block 12) is divided into five tiers: Tier 1 (block 14) is a membership for 1-500 people within the entity, Tier 2 (block 15) is a membership for 501-1000 people within the entity, Tier 3 (block 16) is for 1001-2500 people within the entity, Tier 4 (block 17) is for 2501-5000 people within the entity, and Tier 5 (block 18) is for more than 5000 people within the entity.

The corporate membership (block 12) allows an entity, such as a church, to provide discounted funeral services and related merchandise to their members. For example, a church signs up for a tier 1 membership (block 14) with the membership company (block 11), as a benefit for its members. The church signs an application, pays an enrollment fee and chooses a payment option. The church is then assigned a membership number and a website password. Within 10 days of signing the application, the church submits a list of members who are covered by the tier 1 membership (block 14) and that data is kept for future reference. When a member passes away within the church or in their family, the church contacts the membership company (block 11) via email, telephone, through a website, or any other suitable communications means. After verification that the member was covered by the church's tier 1 membership, access will be given to an on-line merchandise store where caskets, urns, burial garments, vaults and other related items can be purchased at a discount price. Once payment has been received by the membership company (block 11), the merchandise is delivered to a designated funeral home. The designated funeral home may be one owned by the membership company (block 11) or by another non-affiliated funeral home.

Like the corporate membership (block 12), the individual/family membership (block 13) may be divided into tiered membership levels. For example, as shown in FIG. 1, the individual/family membership (block 13) may be broken down into a regular membership (block 20), a plus membership (block 21), and a platinum membership (block 22). The individual/family membership (block 13) covers the individual signing the application and a designated number of family members, for example, four members of their family.

In the illustrated example, the membership levels (blocks 20-22) shown in FIG. 1 may be broken down based on the benefits each level of membership includes. For example, the regular membership (block 20) could provide discounts on caskets, vaults, urns, and burial garments. The plus membership (block 21) could provide discounts on caskets, vaults, urns, burial garments, head stones, and membership cemeteries. The platinum membership (block 22) could provide discounts on caskets, vaults, urns, burial garments, head stones, membership cemeteries, membership florist, membership printing companies, membership airlines, membership hotels, membership restaurants, membership catering service companies, membership dry cleaner companies, membership limo service companies, membership attorneys, membership funeral homes, membership moving companies, membership shipping companies, membership train travel companies, membership bus travel companies, membership car rental companies, and access to a concierge service to answer questions about these companies.

The individual/family membership (block 13) operates essentially in the same manner as the corporate membership (block 12), described above. Namely, a member contacts the membership company (block 11) regarding a deceased member. After verification that the deceased member was covered by the membership, access is given to an on-line merchandise store (or to a local store) where caskets, urns, burial garments, and other related items can be purchased at a discount price. Once payment has been received by the membership company (block 11), the merchandise is delivered to a designated funeral home.

The membership company (block 11) can also provide discounted services to non-members (block 25). Non-members (block 25) will be able to purchase funeral services and merchandise through the membership company (block 11) at a price discounted from typical retail prices provided by funeral homes but higher than an individual who purchased a membership from the membership company (block 11).

In addition, the method 10 can include a profit share program that provides an incentive rebate to its members. For example, each time a member organization utilizes the method 10, a portion of the profits, such as ten percent, is given back to the member organization.

The method 10 can also include a membership referral program. If a company or individual refers another individual or company for memberships, they receive a referral fee.

In addition, the method 10 of the present invention can be the subject of franchising. For example, multiple businesses in particular localities could utilize the method 10 pursuant to franchise agreements.

A method of providing funeral services is described above. Various details of the invention may be changed without departing from its scope. Furthermore, the foregoing description of the preferred embodiments of the invention and best mode for practicing the invention are provided for the purpose of illustration only and not for the purpose of limitation—the invention being defined by the claims.

What is claimed is:

1. A method for providing funeral services and related merchandise comprising the steps of:
(a) providing a membership company for offering and administering memberships, wherein the membership company charges and collects a fee from members; and
(b) entering agreements with providers of funeral services and funeral related merchandise, wherein the providers agree to provide the funeral services and the funeral related merchandise at a predetermined price to members of the membership company.

2. A method according to claim 1, wherein the memberships are for a predetermined period of time selected from the group consisting of monthly, annual and semi-annual.

3. A method according to claim 1, wherein the predetermined price is discounted below a price generally charged by the providers for the services and merchandise.

4. A method according to claim 1, further comprising the step of the membership company charging and collecting a fee from the providers.

5. A method according to claim 1, wherein the funeral related merchandise comprises one or more selected from the group consisting of caskets, flowers, urns, burial garments, and vaults.

6. A method according to claim 1, further comprising the step of the membership company being alerted of the death of one of the members.

7. A method according to claim 6, wherein the membership company is alerted of the death of one of the members through a communication means selected from the group consisting of electronic mail, telephone, and an Internet website.

8. A method according to claim 6, further comprising the steps of:
(a) verifying the member's membership; and
(b) providing access to an on-line store selling funeral related merchandise at a discounted price.

9. A method according to claim 1, further comprising the step of the membership company collecting payment from members for funeral services or funeral related merchandise.

10. A method according to claim 1, further comprising the step of the membership company offering funeral services or funeral related merchandise to non-members at a price higher than the predetermined price charged to members of the membership company.

11. A method according to claim 1, wherein the memberships offered and administered by the membership company are classified into a plurality of tiered membership levels, wherein each level provides varying benefits to the members.

12. A method according to claim 1, wherein the membership company offers and administers corporate memberships and individual/family memberships.

13. A method according to claim 12, wherein the corporate memberships are for entities selected from the group consisting of churches, nursing homes, rest homes, hospice care facilities, for-profit business entities, and non-profit entities.

14. A method according to claim 12, wherein the corporate memberships are classified into a plurality of tiered membership levels based on the number of individuals within a member entity.

15. A method according to claim 14, wherein the tiered membership levels comprise:
(a) a first tier comprised of entities having one to five hundred individuals; and
(b) a second tier comprised of entities having 501 to 1000 individuals.

16. A method according to claim 15, wherein the tiered membership levels further comprise:
(a) a third tier comprised of entities having 1001-2500 individuals; and
(b) a fourth tier comprised of entities having 2501-5000 individuals.

17. A method according to claim 16, wherein the tiered membership levels further comprise a fifth tier comprised of entities having more than five thousand individuals.
